(19) United States
(12) Patent Application Publication
(10) Pub. No.: US 2018/0301026 A1
(43) Pub. Date: Oct. 18, 2018

(54) METHOD AND APPARATUS FOR VEHICLE TRAFFIC CONGESTION PREVENTION

(71) Applicant: Dmitri Yudanov, Austin, TX (US)

(72) Inventor: Dmitri Yudanov, Austin, TX (US)

(21) Appl. No.: 15/486,080

(22) Filed: Apr. 12, 2017

(51) Int. Cl. G08G 1/01; G08G 1/052; G01S 13/91; G01S 17/88

(52) U.S. Cl. CPC G08G 1/0145; G08G 1/0125; G08G 1/0141; H04W 84/042; G01S 13/91; G01S 17/88; G08G 1/052

(57) ABSTRACT

Various traffic management systems and methods are disclosed. In one aspect, a traffic management system is provided that includes an intelligent traffic signal for managing traffic flow at an intersection. The intelligent traffic signal is operable to periodically acquire positions and speeds of one or more vehicles traveling toward the intersection, to compute a recommended speed for the one or more vehicles to transit the intersection without stopping based on the positions and speeds and a time to red or a time to green of the intelligent traffic signal, and transmit the recommended speed to the one or more vehicles. The system further includes one or more vehicles that have a receiver to receive and a device to convey the recommended speeds to the one or more vehicles.

### BACKGROUND OF THE INVENTION

Conventional traffic signal systems that use traffic lights to periodically allow vehicle movement through an intersection in one direction and alternatively in another direction can provide for the orderly movement of vehicles. Several conventional vehicle traffic management systems have been proposed. In one variant, a traffic signal controller continuously broadcasts a signal identifying the traffic signal controller. Incoming vehicles are equipped with a transceiver that receives the traffics signal broadcast and transmits back a signal to the traffic signal controller indicating the presence of the vehicle. The traffic signal controller counts the number of incoming vehicles and sets its green light duration accordingly. In another conventional variant, a traffic light includes a short range radio to transmit its location and phase (green or red) to a user's cell phone. The user's cell phone displays to the user the traffic light phase. In still another conventional variant, a traffic light broadcasts its phase (green or red) to incoming vehicles. The vehicles receive the light phase information and compute their own required speeds to hit the intersection when the light is green. The drivers can choose to use the required speeds or not. These conventional techniques do not take into consideration of the instantaneous status, such as speed and position, of multiple incoming vehicles.

### BRIEF DESCRIPTION OF THE DRAWINGS

The foregoing and other advantages of the invention will become apparent upon reading the following detailed description and upon reference to the drawings in which:

FIG. 1 is an overhead schematic view of an exemplary traffic management system;

FIG. 2 is a schematic view of an exemplary intelligent traffic signal;

FIG. 3 is a schematic view of an exemplary vehicle, vehicle display and portable computing device display; and

FIG. 4 is a flow chart depicting an exemplary traffic management control method.

### DETAILED DESCRIPTION

The requirements for vehicles to repeatedly accelerate and decelerate in and around intersections present certain costs. There are fuel consumption and tire wear penalties associated with rapidly accelerating a vehicle away from a stop. There is significant static and dynamic friction that must be overcome in order to get a multi-thousand pound machine moving on a concrete or asphalt pavement. Conversely, there are fuel consumption, tire and brake wear, and break pad pollution penalties associated with rapidly decelerating a vehicle to a stop. At the stop, the vehicle is burning fuel but not moving. The process of braking produces tire and brake wear, and braking action introduces particulate pollution as brake pads are abraded during braking. Finally, depending on the temperament of the driver, stopping and starting can be a personal annoyance.

In accordance with one aspect of the present invention, a traffic management system is provided that includes an intelligent traffic signal for managing traffic flow at an intersection. The intelligent traffic signal is operable to periodically acquire positions and speeds of one or more vehicles traveling toward the intersection, to compute a recommended speed for the one or more vehicles to transit the intersection without stopping based on the positions and speeds and a time to red or a time to green of the intelligent traffic signal, and transmit the recommended speed to the one or more vehicles. The system further includes one or more vehicles that have a receiver to receive, and a device to convey, the recommended speeds to the one or more vehicles.

In accordance with another aspect of the present invention, a traffic management system is provided that includes an intelligent traffic signal for managing traffic flow at an intersection. The intelligent traffic signal is operable to periodically acquire positions and speeds of one or more vehicles traveling toward the intersection, to compute a recommended speed for the one or more vehicles to transit the intersection without stopping based on the positions and speeds and a time to red or a time to green of the intelligent traffic signal, and transmit via a cellular network the recommended speed to the one or more vehicles. One or more vehicles have a cellular network receiver to receive, and a display to display the recommended speeds.

In accordance with another aspect of the present invention, a method of managing traffic flow at an intersection is provided. The method includes using an intelligent traffic signal positioned at the intersection to periodically acquire positions and speeds of one or more vehicles traveling toward the intersection, compute a recommended speed for the one or more vehicles to transit the intersection without stopping based on the positions and speeds and a time to red or a time to green of the intelligent traffic signal, and transmit the recommended speeds to the one or more vehicles. The one or more vehicles receive the recommended speeds and convey the recommended speeds to the one or more vehicles.

Various traffic management systems and methods are disclosed. A technical aim is to provide multiple vehicles the capability to transit an intersection without stopping. One variant includes an intelligent traffic signal positioned at the intersection. The intelligent traffic signal periodically acquires the positions and speeds of incoming vehicles. The intelligent traffic signal acquires the positions and speeds wirelessly from the vehicles or by interrogating the vehicles with radar or laser range finding. The intelligent traffic signal computes recommended speeds using the acquired position and speed data and the current time to red or time to green for the intelligent traffic signal and transmits the recommended speeds to the vehicles. The intelligent traffic signal can update the recommendations where conditions change, such as when vehicles do not comply with recommended speeds, weather conditions or other changes. The vehicles convey the recommended speeds, and optionally the light phase, to the drivers and/or passengers visually or by audio message. Additional details will now be described.

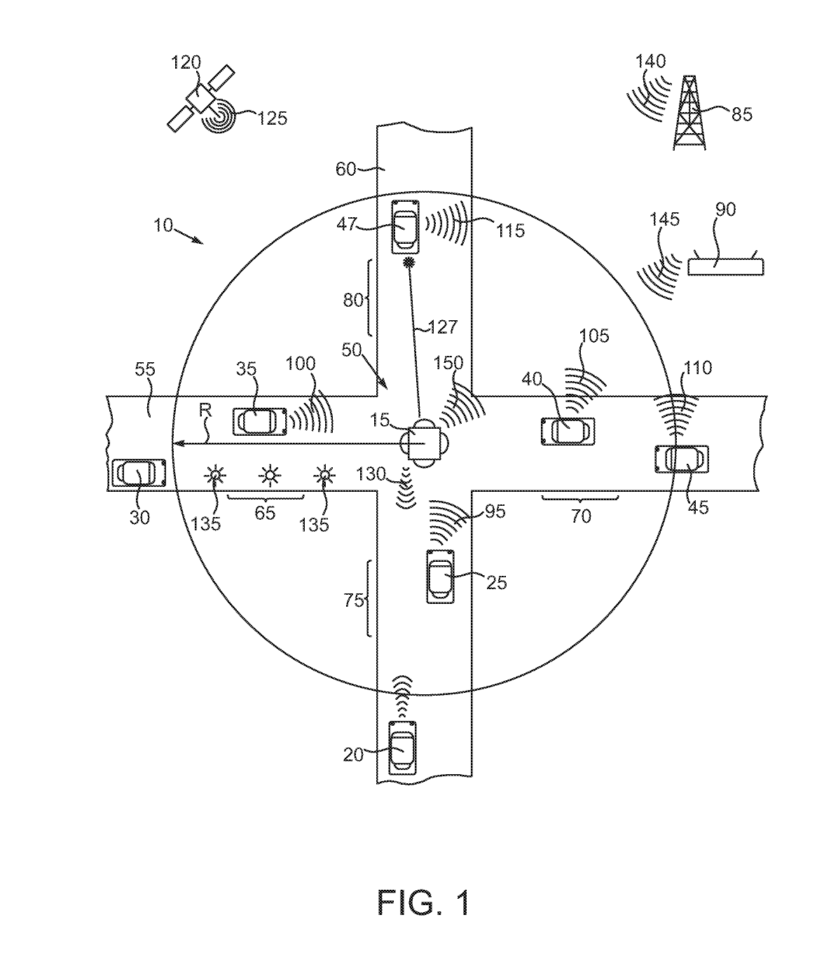

In the drawings described below, reference numerals are generally repeated where identical elements appear in more than one figure. Turning now to the drawings, and in particular to FIG. 1, therein is depicted an overhead schematic view of an exemplary traffic management system 10 (system 10). The system 10 includes an intelligent traffic signal (ITS) 15 that is operable to interact with one or more vehicles, a few of which are depicted and labeled 20, 25, 30, 35, 40, 45 and 47, to manage the flow of traffic in and around an intersection 50 between one or more roads, two of which are shown and labeled 55 and 60, respectively. To facilitate the description provide herein, the road 55 can be described in terms of a road segment 65 and a road segment 70 and the road 60 can similarly be described in terms of a road segment 75 and a road segment 80. Here, the intersection 50 is a four-way intersection. However, two-way intersections, three-way intersections or others can be managed using the devices and techniques disclosed herein. Bi-directional communication between the ITS 15 and the vehicles 20, 25, 30, 35, 40, 45 and 47 can be provided by a cellular network 85, a wi-fi network 90 or other wireless communication system. Assume for the purposes of this illustration that the vehicles 20, 25, 30, 35, 40 and 45 are traveling toward the intersection 50 and the vehicle 47 is traveling away from the intersection 50. As each of the vehicles 20, 25, 30, 35, 40, 45 and 47 comes into a selected distance range R from the ITS 15, those vehicles within range R, and in this illustration vehicles 25, 35, 40, 45 and 47, begin periodically transmitting to the ITS 15 respective data signals 95, 100, 105, 110 and 115 by way of either the cellular network 85, the wi-fi network 90 or some other network. In an exemplary variant, the data signals 95, 100, 105, 110 and 115 include information as to a given vehicle's position and speed. For example, the data signal 105 can include information as to the position of the vehicle 40 as well as the instantaneous speed of the vehicle 40 while the data signal 110 can convey the position of the vehicle 45 as well as the instantaneous speed of the vehicle 45. The same is true for the other vehicles 25, 35 and 47 as well as the vehicles 20 and 30 when those vehicles 20 and 30 eventually come within range R.

The positions of the vehicles 20, 25, 30, 35, 40, 45 and 47 can be determined in a variety of ways. In an exemplary variant, a GPS satellite network 120 can provide GPS position signals 125 to the receiving vehicles 20, 25, 30, 35, 40, 45 and 47. Other satellite positioning systems besides GPS can be used. Glanas is an example of an alternate satellite positioning system. However, the instantaneous positions of the vehicles 20, 25, 30, 35, 40, 45 and 47 can be determined in a variety of ways. For example, the positions of the vehicles 20, 25, 30, 35, 40, 45 and 47 can be determined by a laser range finder 127 connected to or otherwise associated with the ITS 15, by radar ranging 130, again via a device connected to or otherwise associated with the ITS 15 or even by road-based sensors 135, which can be near field communication devices, induction sensors or other types of sensors that are capable of sensing the presence of the vehicles 20, 25, 30, 35, 40, 45 and 47 and either conveying that position information directly to the vehicles 20, 25, 30, 35, 40, 45 and 47 or to the ITS 15.

The determination of whether a given vehicle, e.g., 20, 25, etc., has moved within the range R and thus should begin transmission or moved outside of range R and thus should terminate transmission can be performed in a variety of ways. In one exemplary variant, the ITS 15 broadcasts the value of range R to incoming vehicles 20, 25, etc., by way of the cellular network 85 or the wi-fi network 90. Thus, the incoming vehicle 20 can receive the value of R from the ITS 15 and compare R with its own position data from the GPS positions signals 125 to determine if it has moved within range R. In another variant, the ITS 15 can use a ranging device, such as the laser range finder 127, the radar ranging 130 or the road sensors 135 to sense the position of an incoming vehicle 20 and then signal the vehicle 20 if it has moved within R, again by way of the cellular network 85 or the wi-fi network 90. In still another variant, an incoming vehicle, such as vehicle 20, can store a map of the ITS 15 and its particular range R. With the map data in hand, the vehicle 20 can make a comparison with its own position data from the GPS positions signals 125 to determine if it has moved within range R.

The data signals 95, 100, 105, 110 and 115 are passed from the cellular network 85 or the wi-fi network 90 as signals 140 and 145, respectively. The signals 140 and 145 are transmitted to the ITS 15. The ITS 15 includes logic in the form of a processor or processors as well as software to enable the ITS 15 to aggregate the position and speed information of all the vehicles within the range R, namely vehicles 25, 35, 40, 45 and 47 in FIG. 1, and compute a recommended speed for each of the vehicles 25, 35, 40, 45 and 47 and transmit that recommended speed (and optionally light phase and/or time to change of light phase) information by way of data signals 150 to the cellular network 85 or the wi-fi network 90 and ultimately to the receiving vehicles 25, 35, 40, 45 and 47 so that the vehicles 25, 35, 40, 45 and 47 can adjust their speed accordingly and achieve a stopless or near stopless movement through the intersection 50. To compute the recommended speeds, the ITS 15 takes into consideration its own phase, that is, red, green or yellow, and the time to red and time to green at any given moment in time. It should be understood that range R can be dynamically adjusted according to changing conditions, such as weather conditions that will affect visibility, safety, etc., road conditions, such as ice, rain, whether or not speed limits vary, whether one or more of the vehicles 20, 25, etc., have not complied with the recommended speeds or other factors. Indeed, it can be possible to use a different range for a particular road segment, that is instead of the same range R for all of the road segments 65, 70, 75 and 80, a particular range can be used for one road segment, say segment 65, and because of differing conditions on another road segment, say road segment 75, a different range larger or smaller than the range for road segment 65 can be used. The ITS 15 can track the speeds and positions of the vehicles 25, 35, 40, 45 and 47 coming and going within range R to account for one or more of the vehicles 25, 35, 40, 45 and 47 slowing down in or after passing the intersection 50. The ITS 15 can also be configured to adjust its time to red and/or time to green based on the speeds and positions of the vehicles 25, 35, 40, 45 and 47 to improve vehicular flow and seek to attain stopless movements.

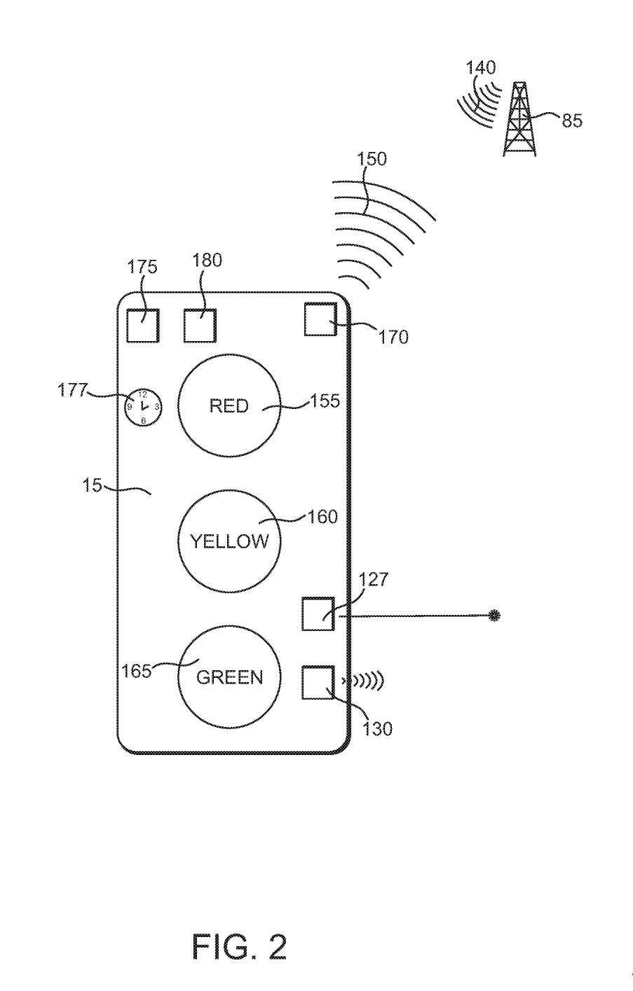

Additional details of an exemplary ITS 15 can be understood by referring now to FIG. 2, which is a schematic view. The ITS 15 can include red, yellow and green lights 155, 160 and 165, respectively, as well as the aforementioned optional laser range finder 127 and radar ranging device 130. To facilitate communication with the cellular network 85, the ITS 15 can include a transceiver 170, which could optionally be a separate receiver and transmitter. The transceiver 170 is operable to transmit the data signals 150 and receive the data signals 140 to facilitate the aforementioned bi-directional communication with the vehicles 20, 25, 30, 35, 40, 45 and 47 depicted in FIG. 1. To facilitate the intelligent functioning of the ITS 15, the ITS 15 can include a processor 175, which can be a CPU, a GPU, an integrated circuit that combines CPU and GPU logic, such as an accelerated processing unit (APU), an application specific integrated circuit, a field programmable gate array or other device. The ITS 15 should include a clock 177 that can synchronize with vehicle clocks as described below. In addition, the ITS 15 can include a storage device 180 to store instructions and data for handling data management and sensing in accordance with the disclosed variants. The storage device 180 can be a non-transitory computer readable medium. Examples include hard drives, optical drives, non-volatile memory or the like.

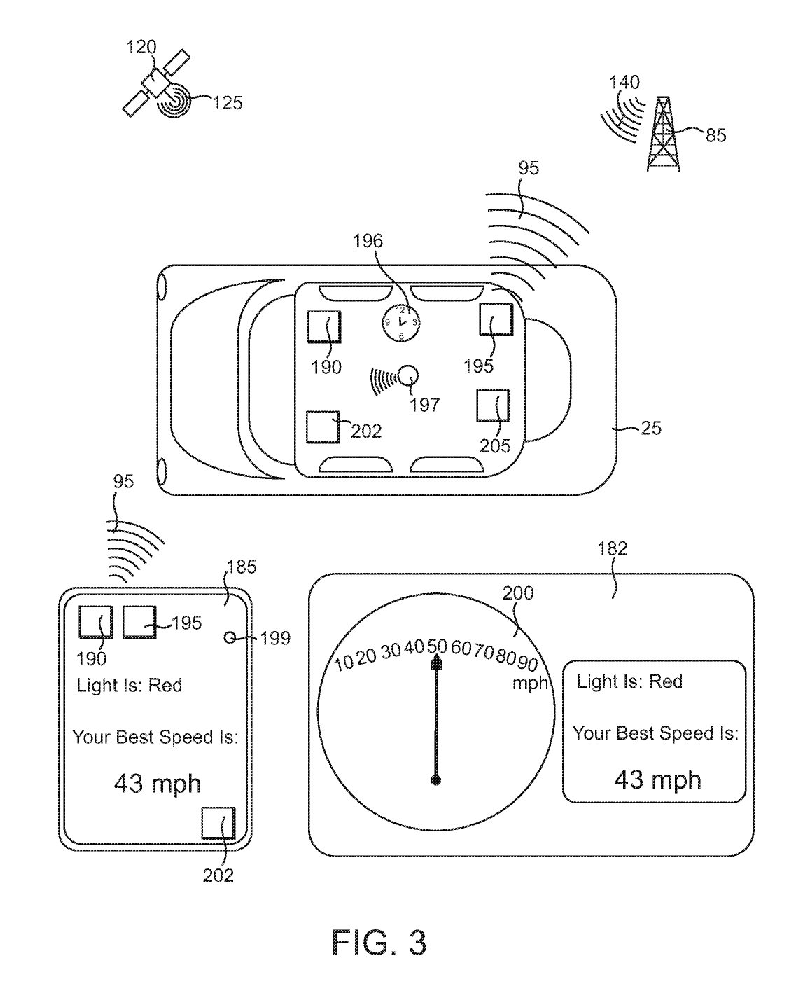

Some exemplary configurations for the vehicles and related equipment can be understood by referring now to FIG. 3, which is a schematic overhead view of an exemplary vehicle 25, an exemplary display 182 of the vehicle 25, as well as a portable computing device 185 that can be used in conjunction with the vehicle 25 to facilitate the traffic management disclosed herein. The following description of the vehicle 25 will be illustrative of the other vehicles 20, 30, 35, 40, 45 and 47 described herein. The vehicle 25 can include a GPS receiver 190 that is operable to receive the GPS signals 125 from the GPS satellite network 120. The GPS receiver 190 can be built into the vehicle 25 or can be incorporated as a GPS receiver 190 in the portable computing device 185. In addition, the vehicle can include a transceiver 195, which can be split into a separate receiver and transmitter as desired, in order to facilitate bi-directional communications with the cellular network 85 (or wife network not shown in FIG. 3) and thus transmission of data signals 95 and reception of data signals 140. Optionally, the transceiver 195 can be, like the GPS receiver 190, built directly into the vehicle 25 or be integrated into the portable computing device 185 as a transceiver 195. A clock 196 in or part of the vehicle 25 can be used to time stamp all data sent by the vehicle 25 (such as speed, position) for use by the algorithm(s) to compute recommended speeds. The time of information generation can be different due to variability in the information propagation delay via the network 85 unless that delay is negligible or the optional radar or other ranging is used. The vehicle clock 196 should be synchronized with the clock 177 of the ITS 15 (see FIG. 2). The vehicle 25 can include a device to communicate to the driver the recommended speed and, optionally, the current light phase (e.g., red, yellow or green). The device can be the display 182 or a sound system 197 to output an audio message to the driver. The vehicle 25 can include instructions in the form of a non-transient computer readable medium to implement an application or software program to provide not only communication of position, data and speed to the cellular network 85 and thus ultimately to the ITS 15 but also to manage reception of the recommended speeds via the data signals 140 (and data signals 150 shown in FIG. 1) and in addition to provide a visual display or audible message to the user of the current light phase (e.g., red, yellow or green or time to such) of the ITS 15 as well as a recommended speed. In this illustrative variant, the vehicle display 182 can indicate that the light is currently red and that a recommended speed is 43 miles per hour in order to achieve a stopless passage through the intersection 50 shown in FIG. 1. Optionally, that information can be conveyed by the sound system 197. Of course the software application can provide both the light phase as well as the recommended speed on the display of the portable computing device 185 in addition to or in lieu of providing that information on the display 182 of the vehicle. In another option, the portable computing device 185 can, from its speaker 199, output an audio message with the recommended speed and optional light phase information. Here, the display 182 also includes a speedometer 200. The vehicle 25 and/or the portable computing device 185 can include a processor 202 (which can be like the processor 175 described elsewhere herein) to run the software application and perform the other disclosed operations. The vehicle 25 can be equipped with a cruise control 205 that can be operable to control the speed of the vehicle 25. The cruise control 205 can be set to a particular speed based on settings imposed by the driver or by way of data signals 140 and recommended speeds broadcast by the ITS 15 shown in FIG. 1. Allowing the cruise control 205 to manage speed based on the data signals 140 can reduce the task burden for the driver. The cruise control 205 can also be a device to convey recommended speeds to a driver by simply adjusting the vehicle 25 to a recommended speed, since such adjustments can be sensed by the driver. If the vehicle 25 is capable of driverless operation, then the recommended speed can be conveyed to the vehicle 25. In such case, the recommended speed can optionally be displayed or otherwise communicated to vehicle occupants.

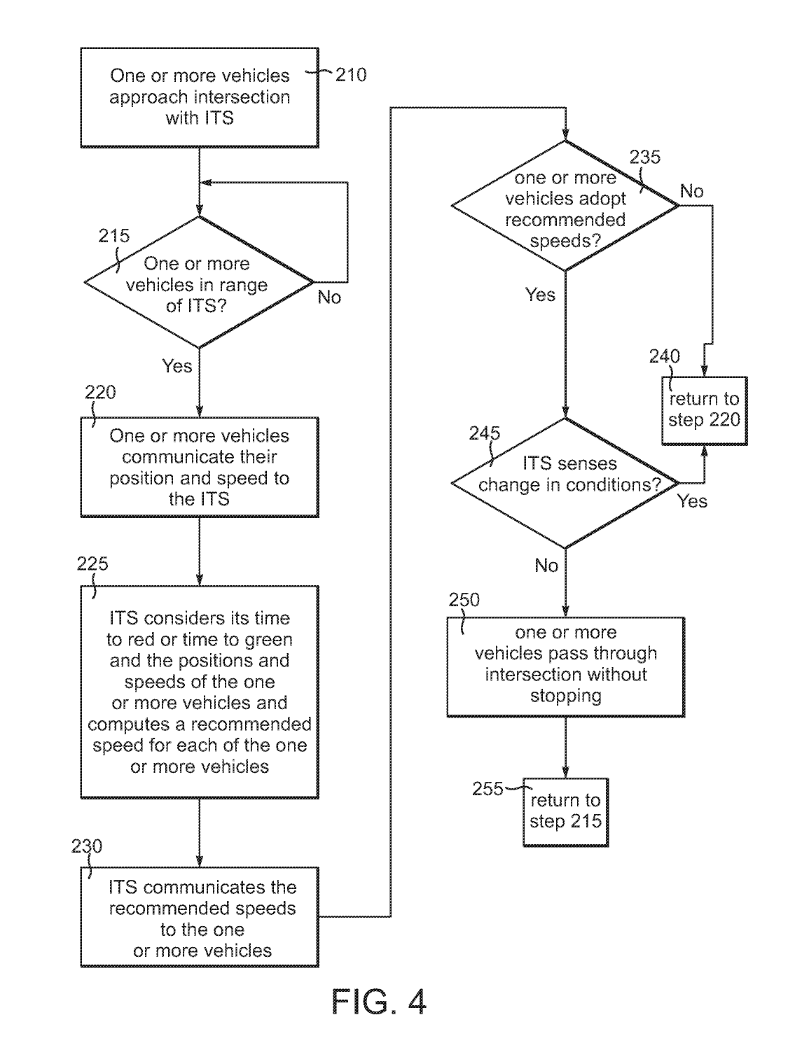

An exemplary method for attempting to achieve stopless movement of vehicles relative to the intersection depicted in FIG. 1 can be understood by referring now also to the flowchart depicted in FIG. 4. At step 210, one or more vehicles can be approaching or moving away from the intersection with an ITS (ITS). This can correspond to the one or more vehicles 20, 25, etc., approaching or moving away from the intersection 50 equipped with the ITS 15. At step 215, it is determined if one or more of the vehicles is in range (range R) of the ITS 15. If at step 215, one or more vehicles are not in range of the ITS 15, then a step back to the beginning of step 215 is performed. If, however, at step 215 it is determined that there are one or more vehicles in range of the ITS 15, then at step 220 one or more vehicles communicate their position and speed, perhaps repeatedly, to the ITS 15. Of course step 220 can be replaced or augmented by the ITS 15 determining the position and speed of the vehicles by way of the techniques disclosed elsewhere herein. At step 225, the ITS 15 considers its own time to red or time to green and the positions and speeds of the one or more vehicles and, using that information, computes a recommended speed for each of the one or more vehicles. The recommended speeds are selected to avoid collisions between the various vehicles 20, 25, etc. Various algorithms can be used and implemented using, for example, linear programming, linear algebra, expectation-maximization, neural nets or any other off-the-shelf available technique. One such algorithm can be as follows. The arrival time to the ITS 15 for each vehicle 20, 25, etc., is computed. If that time is within the red time period of the ITS 15, then new speeds are computed for the vehicles 20, 25, etc., based on time to green period. Speeds are selected to assure that conflicts in space between vehicles 20, 25, etc. will not occur. At step 230, the ITS 15 communicates the recommended speeds to the one or more vehicles. At step 235, the ITS 15 determines if one or more of the vehicles have adopted the recommended speeds, and this can be with or without the cruise control enabled. This is an important step since the failure of one or more other vehicles to adopt the recommended speeds can jeopardize the safe passage of the one or more vehicles through the intersection or otherwise result in less than a stopless passage. This determination can involve a repeat of step 220 or the alternative thereof where the ITS 15 determines the position and speed by sensing using the techniques disclosed herein. If at step 235, it is determined that one or more vehicles have not adopted the recommended speeds then at step 240 a return to step 220 is performed. If, however, at step 235 it is determined that the one or more the vehicles have adopted the recommended speeds then at step 245, the ITS 15 senses for any changes in conditions that might impact the safety or convenience of the vehicles traversing the intersection 50. For example, at step 245 the ITS 15 can sense a change in weather, a sudden change in the number of approaching vehicles or other factors. If at step 245 the ITS 15 has sensed a change in conditions, then a return is made to step 240 and thus to step 220. If, however, at step 245 the ITS 15 does not sense a change in conditions, then at step 250 the one or more vehicles pass through the intersection 50 without stopping, and this is followed by step 255 and a return to step 215. This cycle of process steps will repeat over and over as vehicles approach and depart the intersection while in range.

Some additional optional variants will now be described. One alternative variant can be used in intersections equipped with stop signs, both two-way and four-way. The same general techniques described herein can be applied. Of course, the legal environment in a given jurisdiction may have to be modified in order to allow vehicles to skip coming to a stop at the stop sign. The intersection should be equipped with cameras/radars to watch for pedestrians and take them into account in managing vehicle flow. Approaching pedestrians, like cars but much slower, can be tracked by radars without reporting any speed/position.

In addition to listed processing devices (CPU, GPU, APU) cloud servers could be used. Some or all of the required computations could be offloaded to one or more cloud servers. This alternative adds additional safety, since cloud-based computing can replicate and protect computation.

In another alternate variant, vehicles 20, 25, etc., could report just their positions. From two consecutive position messages received from a given vehicle 20, 25, etc., the ITS 15 could compute the instantaneous actual speed of the given vehicle 20, 25, etc. From three or more reported positions the ITS 15 could compute a vehicle's acceleration. Of course, the vehicles could compute their own accelerations and transmit that information to the ITS 15. Knowledge of a given vehicle 20, 25, etc. acceleration can enable the ITS 15 to react faster to the changes on the road.

In still another alternative variant, vehicles 20, 25, etc., could transmit metadata to the ITS 15. The types of transmitted metadata could be numerous. Examples includes vehicle weight, number of people on board, the presence of a children/babies on board, vehicle intended route, vehicle type (police, ambulance) etc. With this information, the ITS 15 could make decisions and recommendations based on priority and vehicle intentions.

While the invention can be susceptible to various modifications and alternative forms, specific variants have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A traffic management system, comprising:
an intelligent traffic signal for managing traffic flow at an intersection, the intelligent traffic signal being operable to periodically acquire positions and speeds of one or more vehicles traveling toward the intersection, to compute a recommended speed for the one or more vehicles to transit the intersection without stopping based on the positions and speeds and a time to red or a time to green of the intelligent traffic signal, and transmit the recommended speed to the one or more vehicles; and
one or more vehicles having a receiver to receive and a device to convey the recommended speeds to the one or more vehicles.

2. The traffic management system of claim 1, wherein the intelligent traffic signal acquires the positions and speeds from the one or more vehicles.

3. The traffic management system of claim 2, wherein the one or more vehicles comprise satellite positioning system receivers and determine their own positions and speeds from satellite positioning system signals and communicate the positions and speeds to the intelligent traffic signal.

4. The traffic management system of claim 1, wherein the intelligent traffic signal comprises a radar or a laser range finder, the intelligent traffic signal acquires the positions and speeds by sensing the positions and speeds of the one or more vehicles with the radar or the laser range finder.

5. The traffic management system of claim 1, wherein the intelligent traffic signal transmits the recommended speed via a cellular network.

6. The traffic management system of claim 1, wherein the intelligent traffic signal transmits the recommended speed via a WIFI network.

7. The traffic management system of claim 1, wherein the device comprises a visual display.

8. The traffic management system of claim 1, wherein the device comprises an audio output system.

9. The traffic management system of claim 1, wherein the receiver and the device comprise components of the one or more vehicles.

10. The traffic management system of claim 1, wherein the receiver and the device comprise components of a portable computing device positionable in the one or more vehicles.

11. The traffic management system of claim 1, wherein the intelligent traffic signal does not acquire the positions and speeds until each of the one or more vehicles comes within a preselected range of the intelligent traffic signal.

12. A traffic management system, comprising:
an intelligent traffic signal for managing traffic flow at an intersection, the intelligent traffic signal being operable to periodically acquire positions and speeds of one or more vehicles traveling toward the intersection, to compute a recommended speed for the one or more vehicles to transit the intersection without stopping based on the positions and speeds and a time to red or a time to green of the intelligent traffic signal, and transmit via a cellular network the recommended speed to the one or more vehicles; and
one or more vehicles having a cellular network receiver to receive and a display to display the recommended speeds.

13. The traffic management system of claim 12, wherein the intelligent traffic signal acquires the positions and speeds from the one or more vehicles.

14. The traffic management system of claim 13, wherein the one or more vehicles comprise satellite positioning system receivers and determine their own positions and speeds from satellite positioning system signals and communicate the positions and speeds to the intelligent traffic signal via the cellular network.

15. The traffic management system of claim 12, wherein the intelligent traffic signal comprises a radar or a laser range finder, the intelligent traffic signal acquires the positions and speeds by sensing the positions and speeds of the one or more vehicles with the radar or the laser range finder.

16. The traffic management system of claim 12, wherein the intelligent traffic signal does not acquire the positions and speeds until each of the one or more vehicles comes within a preselected range of the intelligent traffic signal.

17. A method of managing traffic flow at an intersection, comprising:
using an intelligent traffic signal positioned at the intersection, periodically acquiring positions and speeds of one or more vehicles traveling toward the intersection, computing a recommended speed for the one or more vehicles to transit the intersection without stopping based on the positions and speeds and a time to red or a time to green of the intelligent traffic signal, and transmitting the recommended speeds to the one or more vehicles; and
the one or more vehicles receiving the recommended speeds and conveying the recommended speeds to the one or more vehicles.

18. The method of claim 17, wherein the intelligent traffic signal acquires the positions and speeds from the one or more vehicles.

19. The method of claim 18, wherein the one or more vehicles comprise GPS receivers and determine their own positions and speeds from GPS signals and communicate the positions and speeds to the intelligent traffic signal.

20. The method of claim 17, wherein the intelligent traffic signal acquires the positions and speeds by sensing the positions and speeds of the one or more vehicles with a radar or a laser range finder.
